(19) United States
(12) Patent Application Publication
(10) Pub. No.: US 2004/0075310 A1
(43) Pub. Date: Apr. 22, 2004

(54) Heatproof car seat arrangement

(76) Inventor: Jianping Wang, Temple City, CA (US)

Correspondence Address: Raymond Y. Chan, 108 N. Ynez Avenue, Suite 128, Monterey Park, CA, 91754, US

(21) Appl. No.: 10/274,472

(22) Filed: Oct. 21, 2002

(51) Int. Cl. B60N 2/60

(52) U.S. Cl. 297/184.11

(57) ABSTRACT

A heatproof car seat arrangement includes a seat panel having a seat contacting layer for placing on a seat support of a car seat, a back panel having a back contacting layer and a radiation shield layer overlappedly attached thereto, wherein the back panel is capable of folding between a driving position and a shading position. At the driving position, the back panel is folded towards to a back support of the car seat, so that both the seat and the back contacting layers provide a cooling surface for body-contacting with a driver to sit thereon, and at the shading position, the back panel is folded forwardly for covering on a steering wheel and shading the seat contacting layer while the radiation shield layer faces upwardly for blocking heat entering into a driving chamber of the vehicle so as to keep the driving chamber in a cooling manner.

### BACKGROUND OF THE PRESENT INVENTION

1. Field of Invention

The present invention relates to a car seat, and more particularly to a heatproof car seat arrangement, which is capable of functioning not only as an air ventilating seat mat detachably placing on a car seat for air ventilation purpose but also as a sun shield for shading a driving chamber in the car so as to keep the driving chamber in a cool condition.

2. Description of Related Arts

Driving in the summer time is a nuisance since the driver directly exposes under the sunlight. Therefore, most of the drivers must turn on the air conditioning in order to set an acceptable climate condition inside the interior of the vehicle. However, air conditioning does not work in a cost effective and energy efficient method to cool down the interior temperature of the vehicle. Moreover, once the air conditioning is off, the hot air is trapped inside the vehicle. Especially when the driver gets in the vehicle, the driver can feel the heat flowing in front of his or her face.

In order to prevent the heat entering into the vehicle, the driver can tint the vehicle window to block the sunlight directly entering into the vehicle so as to prevent the interior temperature of the vehicle from rising by the heat of the sunlight. However, the tinted window of the vehicle is not allowed in some countries due to the safety purpose.

Some drivers would like to purchase a seat mat placing on the car seat wherein the seat mat has a ventilating side for the driver comfortably sitting thereon. Accordingly, the ventilating side of the seat mat is made of heat dispersing element such as bamboo pieces or stones adapted for quickly dispersing the heat so as to provide a cooling surface for the driver sitting thereon. However, when the heat dispersing element is exposed under the sun for a while, the temperature of the ventilating side of the seat mat is even higher than the temperature of the car seat surface. Therefore, the driver must wait for a period of time to let the heat vanishing from the heat dispersing element.

Alternatively, the driver is able to purchase a reflecting panel to put on the windshield for blocking the sunlight entering into the interior of the vehicle in such a manner that before the driver leaves the vehicle, the driver can simply place the reflecting panel at an inner side of the vehicle window. It is a hassle for the driver to put on and take off each reflecting panel every time when the driver leaves and get in the vehicle respectively. Moreover, the size of the reflecting panel is relatively big for the user to carry and store. Even though the reflecting panel can be overlappedly folded into a compact size, it is annoying for the driver to fold up the reflecting panel into the compact form.

In addition, the reflecting panel can only block the sunlight from the windshield such that the driving chamber is still heated up when the sunlight enters from other windows. Accordingly, the driving chamber is provided at a driver side of the vehicle for the driving in a body-contacting manner. In other words, the driver seat and the steering wheel is provided in the driving chamber that the driver sits on the driver seat and grips the steering wheel. Therefore, even though the reflecting panel can reduce the interior temperature of the vehicle, the driver seat and the steering wheel are hot that the driver will feel uncomfortable when he or she stays in the driving chamber.

### SUMMARY OF THE PRESENT INVENTION

A main object of the present invention is to provide a heatproof car seat arrangement, which is capable of functioning not only as an air ventilating seat mat detachably placing on a car seat for air ventilation purpose but also as a sun shield for shading a driving chamber in the car so as to keep the driving chamber in a cool condition.

Another object of the present invention is to provide a heatproof car seat arrangement, wherein a back panel of the car seat arrangement is capable of folding forwardly to not only covering the steering wheel but also shading a seat panel so as to give a pleasant shade for the body-contacting area within the driving chamber.

Another object of the present invention is to provide a heatproof car seat arrangement, wherein each of the back and seat panels has an air ventilating side for dispersing the heat to provide a comfortable cooling surface for the driver sitting thereon. Since the back and seat panels are folded to cover with each other, the car seat arrangement can keep the air ventilating sides in a cooling manner.

Another object of the present invention is to provide a heatproof car seat arrangement, wherein the shading operation of the present invention is quick and simple that by folding the back panel forward to cover the steering wheel.

Another object of the present invention is to provide a heatproof car seat arrangement, which is specifically designed not only for the driver side of the vehicle but also for the passenger side of the vehicle so as to provide a cool body-contact surface of the car seat.

Another object of the present invention is to provide a heatproof car seat arrangement, wherein no expensive or complicated structure is required to employ in the present invention in order to achieve the above mentioned objects. Therefore, the present invention successfully provides an economic and efficient solution not only for providing a cooling seat surface for the driver sitting thereon but also for shading the driving chamber to keep body-contacting area within the driving chamber in a cooling manner.

Accordingly, in order to accomplish the above objects, the present invention provides a heatproof car seat arrangement for shading a driving chamber of a vehicle comprising a car seat and a steering wheel locating within the driving chamber, comprising:

a seat panel, which is adapted for placing on a seat support of the car seat, comprising a seat contacting layer;

a back panel, which is foldably extended from the seat panel, comprising a back contacting layer and a radiation shield layer overlappedly attached thereto, wherein the back panel is capable of folding between a driving position and a shading position, wherein at the driving position, the back panel is folded towards to a back support of the car seat, so that both the seat contacting layer and the back contacting layer provide a cooling surface for body-contacting with a driver to sit thereon, and at the shading position, the back panel is folded forwardly for covering on the steering wheel and shading the seat contacting layer of the seat panel, and the radiation shield layer of the back panel faces upwardly for blocking heat entering into the driving chamber so as to keep the driving chamber in a cooling manner; and

means for detachably fastening the radiation shield layer of the back panel on the back support of the car seat to retain the back panel on the car seat in position.

Accordingly, the present invention further provides a method of shading the driving chamber of the vehicle, comprising the steps of:

(a) placing the heatproof car seat arrangement on the car seat of the vehicle wherein the seat panel is positioned on the seat support of the car seat and the back panel is positioned on the back support of the car seat;

(b) providing the fastening means on the back panel for detachably fastening the back panel on the back support of the car seat, so that the seat panel and the back panel provide a cooling surface for body-contacting with a driver to sit thereon; and

(c) forwardly folding the back panel to detach the back panel from the back support of the car seat for covering on the steering wheel and shading the seat panel, so as to keep the driving chamber in a cooling manner.

### BRIEF DESCRIPTION OF THE DRAWINGS

FIG. 1 is a perspective view of a heatproof car seat arrangement according to a first preferred embodiment of the present invention.

FIG. 2 is a perspective view of the heatproof car seat arrangement employed in a driving chamber of a vehicle according to the above first preferred embodiment of the present invention, illustrating the heatproof car seat arrangement in a driving position.

FIG. 3 is a perspective view of the heatproof car seat arrangement in a shading position according to the above first preferred embodiment of the present invention.

FIG. 4 is a perspective view a heatproof car seat arrangement according to a second preferred embodiment of the present invention.

FIG. 5 is a perspective view of the heatproof car seat arrangement in a shading position according to the above second preferred embodiment of the present invention.

### DETAILED DESCRIPTION OF THE PREFERRED EMBODIMENT

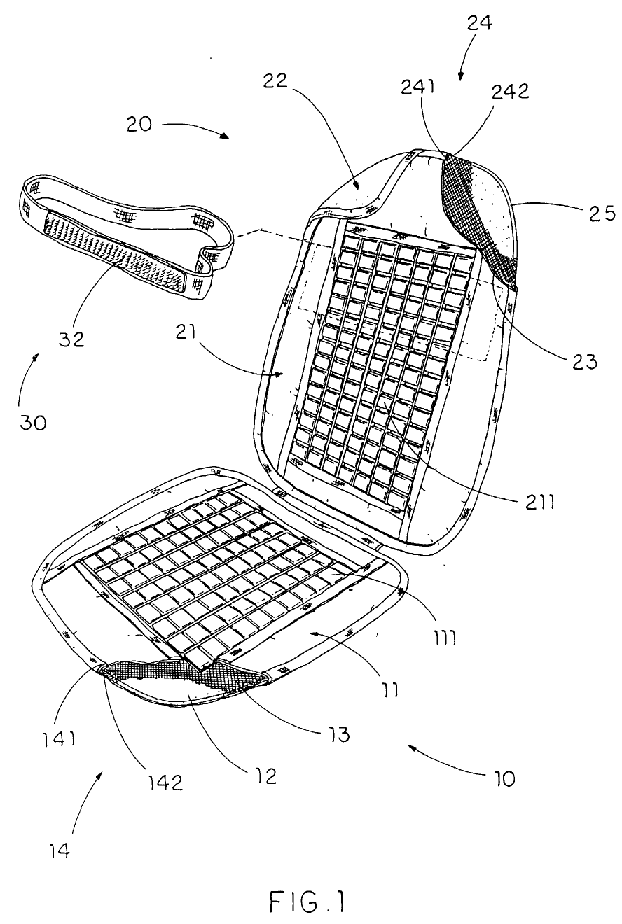

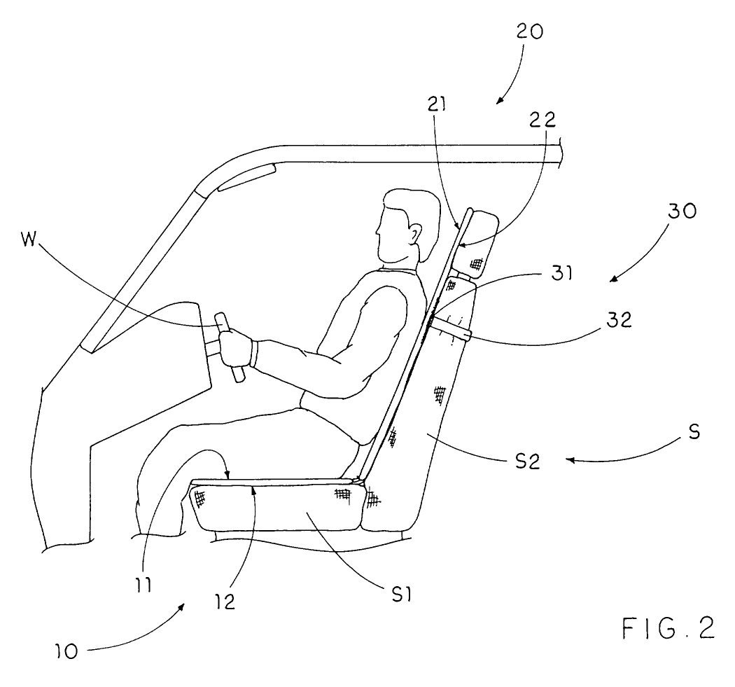

Referring to FIGS. 1 and 2 of the drawings, a heatproof car seat arrangement for a vehicle according to a first preferred embodiment of the present invention is illustrated, wherein the heatproof car seat arrangement is capable for shading a driving chamber of a vehicle so as to keep the driving chamber in a cooling manner, wherein the vehicle comprises a car seat S and a steering wheel W locating within the driving chamber.

According to the preferred embodiment, the heatproof car seat arrangement comprises a seat panel 10 and a back panel 20 wherein the seat panel 10, which is adapted for placing on a seat support S1 of the car seat S, comprises a seat contacting layer 11.

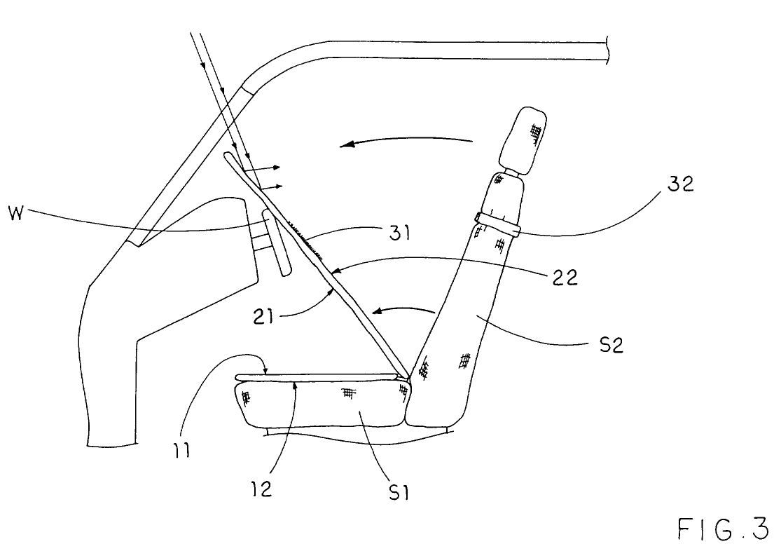

The back panel 20, which is foldably extended from the seat panel 10, comprises a back contacting layer 21 and a radiation shield layer 22 and overlappedly attached thereto, wherein the back panel 20 is capable of folding between a driving position and a shading position. At the driving position, the back panel 10 is folded towards to a back support S2 of the car seat S, so that both the seat contacting layer 11 and the back contacting layer 21 provide a cooling surface for body-contacting with a driver to sit thereon, as shown in FIG. 2. At the shading position, the back panel 20 is folded forwardly for covering on the steering wheel W and shading the seat contacting layer 11 of the seat panel 10, and the radiation shield layer 22 of the back panel 20 faces upwardly for blocking heat entering into the driving chamber so as to keep the driving chamber in a cooling manner, as shown in FIG. 3.

The heatproof car seat arrangement further comprises means 30 for detachably fastening the radiation shield layer 22 of the back panel 20 on the back support S2 of the car seat S to retain the back panel 20 on the car seat S in position.

As shown in FIG. 1, the seat panel 10 further comprises a bottom layer 12 wherein the seat contacting layer 11 is overlapped on the bottom layer 12. The seat contacting layer 11 is embodied as a seat ventilating layer comprising a plurality of heat dispersing elements 111, such as bamboo piece or stone, connected with each other to form an air ventilating surface wherein each of the heat dispersing elements 111 is capable of quickly vanishing the heat to provide a cooling surface. It is worth to mention that each of the heat dispersing elements 111 can be shaped to provide a massage function when the driver sits on the seat contacting layer 11 of the seat panel 10.

The seat panel 10 further comprises a reinforcing layer 13 overlapped between the seat contacting layer 11 and the bottom layer 12 for strengthening the seat panel 10. As shown in FIG. 1, the reinforcing layer 13 comprises by a plurality of durable wires constructed to form a web-liked layer sandwiched between the seat contacting layer 11 and the bottom layer 12.

In order to form the seat panel 10, an elongated first edge strap 14, having a U-shaped cross section longitudinally defining a top leaf 141 and a bottom leaf 142, extended along a side edge of the seat panel 10 to securely sandwich side edges of the seat contacting layer 11, the bottom layer 12 and the reinforcing layer 13 between the top leaf 141 and the bottom leaf 142.

According to the preferred embodiment, the back panel 20 is shaped and sized adapted to cover on the steering wheel W when the back panel 20 is folded forwardly, wherein the back contacting layer 21 is embodied as a front side of the back panel 20 for body-contacting with the driver's back at the driving position and the radiation shield layer 22 is embodied as a rear side of the back panel 20 for blocking the heat from the exterior of the vehicle entering into the driving chamber thereof at the shading position. In other words, the steering wheel W is kept away from exposing to the outside so as to remain the steering wheel W in a cooling condition when the back panel 20 is covered thereon.

The back contacting layer 21 of the back panel 20 is embodied as a back ventilating layer constructed by a plurality of heat dispersing elements 211 connected with each other so that the heat dispersing elements 211 of the back contacting layer 21 are capable of quickly vanishing the heat to provide a cooling surface of the back panel 20. It is worth to mention that the seat contacting layer 11 and the back contacting layer 21 can be constructed as cushion layers to provide a soft and comfort surface for the driver sitting thereon. Since the seat contacting layer 11 and the back contacting layer 21 are shaded by the radiation shield layer 22, the seat contacting layer 11 and the back contacting layer 21 can keep in a cooling condition when the driver sits thereon.

The back panel 20 further comprises a strengthen layer 23 overlappedly disposed between the back contacting layer 21 and the radiation shield layer 22 for strengthening the back panel 20 so as to reinforce the back panel 20 for covering on the steering wheel W when the back panel 20 is folded forward. The strengthen layer 23, embodied as the reinforcing layer 13 of the seat panel 10, comprises a plurality of durable wires constructed to form a web-liked layer sandwiched between the back contacting layer 21 and the radiation shield layer 22.

Likewise, an elongated second edge strap 24, having a U-shaped cross section longitudinally defining a first leaf 241 and a second leaf 242, is extended along a side edge of the back panel 20 to securely sandwich side edges of the back contacting layer 21, the radiation shield layer 22, and the strengthen layer 23 between the first leaf 241 and the second leaf 242.

The back panel 20 further comprises a reinforcing rim 25 encirclingly attached to the side edge of the back panel 20 to retain the shape thereof wherein the reinforcing rim 25 is sandwiched between the first leaf 241 and the second leaf 242 of the second edge strap 24.

The fastening means 30 comprises a first fastener 31 provided on the radiation shield layer 22 and a second fastener 32 which is adapted for detachably mounting on the back support S2 of the car seat S and is arranged to detachably fasten with the first fastener 31 so as to retain the back panel 20 on the back support S2 of the car seat S. Accordingly, the first and second fasteners 31, 32 are hoop and loop fasteners, wherein the second fastener 32 is embodied as an elastic loop form tightly encircling with the back support S2 of the car seat S such that the driver is able to adjust a position of the second fastener 32 with respect to the back support S2 of the car seat S to detachably fasten with the first fastener 31 when the back panel 20 is folded towards to the back support S2 of the car seat S at the driving position.

According to the first preferred embodiment, the present invention further provides a method of shading the driving chamber of the vehicle, which comprises the following steps.

(1) Place the heatproof car seat arrangement within the driving chamber of the vehicle wherein the seat panel 10 is put on the seat support S1 of the car seat S while the back panel 20 is positioned on the back support S2 of the car seat S.

(2) Fasten the back panel 20 on the car seat S by attaching the first fastener 31 on the radiation shield layer 22 and mounting the second fastener 32 on the back support S2 of the car seat S, wherein when the back panel 20 is folded towards to the back support S2 of the car seat S, the first fastener 31 is detachably fastened with the second fastener 32 so as to retain the back panel 20 on the back support S2 in position.

(3) Forwardly fold the back panel 20 to detach the first fastener 31 from the second fastener 32 for covering the steering wheel W and shading the seat panel 10, so as to keep the driving chamber in a cooling manner.

As shown in FIG. 3, when the back panel 20 is folded at the shading position, i.e. when the driver leaves the vehicle, the back contacting layer 21 is laid on the steering wheel W such that the radiation shield layer 22 is folded to face upwardly to reflect the heat from outside so as to prevent the steering wheel W from being exposed outside. In addition, the seat panel 10, especially the seat contacting layer 11 is shaded by the back panel 20 so that both the seat contacting layer 11 and the back contacting layer 21 are shaded to keep at the cooling condition.

Therefore, when the driver gets in the vehicle, he or she is able to fold the back panel 20 towards to the back support S2 of the car seat S, so that the seat contacting layer 11 and the back contacting layer 21 provide a cooling surface for the driver to sit thereon. Moreover, since the steering wheel W is shaded by the back panel 20, the driver is able to grip the steering wheel W without burning his or her hands.

It is worth to mention that due to the weight of the back panel 20, the back panel 20 will substantially cover the steering wheel W when the back panel 20 is folded forwardly by gravity. Thus, since the back support S2 of the car seat S is inclinedly extended from the seat support S1 thereof, the back panel 20 will lay on the back panel 20 when the back panel 20 is folded towards to the back support S2 of the car seat S.

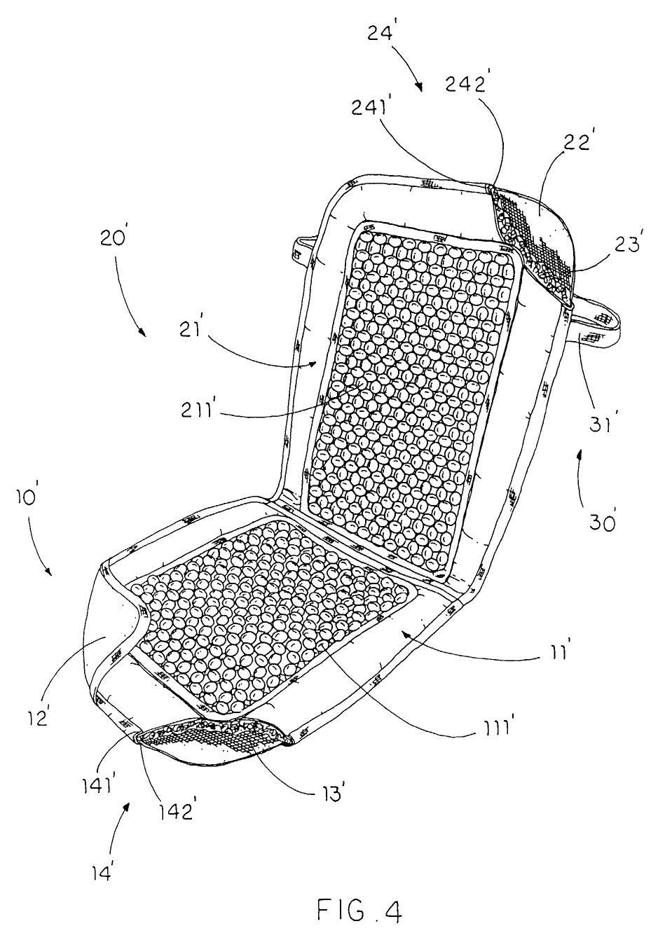

As shown in FIG. 4, a heatproof car seat arrangement of a second embodiment illustrates an alternative mode of the first embodiment of the present invention, wherein the heatproof car seat arrangement comprises a seat panel 10′ and a back panel 20′ foldably extended from the seat panel 10′.

The seat panel 10′ comprises a seat contacting layer 11′ and a radiation shield layer 12′ overlappedly attached thereto, wherein the seat panel 10′ is capable of folding between a driving position and a shading position. The seat panel 10′ further comprises a reinforcing layer 13′, which is shaped as a web-liked layer, overlapped between the seat contacting layer 11′ and the radiation shield layer 12′ for strengthening the seat panel 10′ so as to reinforce the seat panel 10′ for covering on the back panel 20′ when the seat panel 10′ is folded upwardly.

In addition, an elongated first edge strap 14′, having a U-shaped cross section longitudinally defining a top leaf 141′ and a bottom leaf 142′, extended along a side edge of the seat panel 10′ to securely sandwich side edges of the seat contacting layer 11′, the radiation shield layer 12′ and the reinforcing layer 13′ between the top leaf 141′ and the bottom leaf 142′.

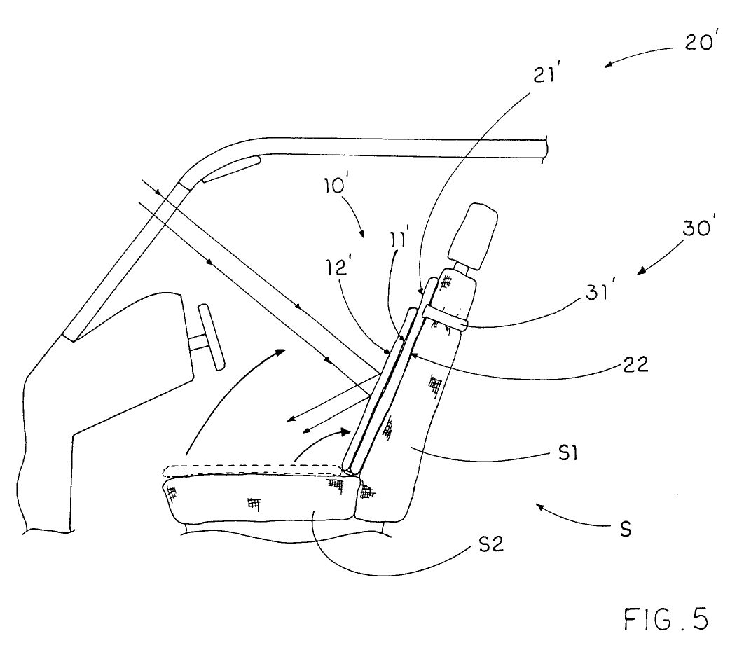

The back panel 20′, which is adapted for placing on the back support S2 of the car seat S, comprises a back contacting layer 21′, wherein at the driving position, the seat panel 10′ is arranged for folding on the seat support S1 of the car seat S so that both the seat contacting layer 11′ and the back contacting layer 21′ provide a cooling surface for body-contacting with a driver to sit thereon, and at the shading position, the seat panel 10′ is folded upwardly to overlappedly cover on the back panel 20′ while the radiation shield layer 22′ faces forwardly for blocking heat entering into the seat contacting layer 11′ and the back contacting layer 21′, as shown in FIG. 5.

The back panel 20′ further comprises a rear layer 22′ overalppedly attached to the back contacting layer 21′ and a strengthen layer 23′, which is shaped as a web-liked layer, overlappedly disposed between the back contacting layer 21′ and the rear layer 22′ for strengthening the back panel 20′. An elongated second edge strap 24′, having a U-shaped cross section longitudinally defining a first leaf 241′ and a second leaf 242′, is extended along a side edge of the back panel 20′ to securely sandwich side edges of the back contacting layer 21′, the rear layer 22′, and the strengthen layer 23′ between the first leaf 241′ and the second leaf 242′.

According to the preferred embodiment, the seat contacting layer 11′ of the seat panel 10′ and the back contacting layer 21′ of the back panel 20′ are embodied as a seat ventilating layer and a back ventilating layer respectively, wherein each of the seat and back ventilating layers 11′, 21′ comprises a plurality of heat dispersing elements 111′, 211′ connected with each other to form an air ventilating surface for the driver sitting thereon. Preferably, the seat panel 10′ should be shaped and sized corresponding to the back panel 20′ such that when the seat panel 10′ is folded upwardly to the back panel 20′, the seat panel 10′ should entirely cover on the back panel 20′, so as to maximize the shading area of the seat panel 10′ for shading the seat and back contacting layers 11′, 21′ by the radiation shield layer 22′.

The heatproof car seat arrangement further comprises means 30′ for detachably fastening the back panel 20′ on the back support S2 of the car seat S. The fastening means 30′ comprises an elastic band 31′ having two ends securely attaching to two opposed side edges of the back panel 20′ at the rear layer 22′ thereof respectively in such a manner that the elastic band 31′ is capable of tightly encircling with the back support S2 of the car seat S so as to retain the back panel 20′ on the back support S in position and selectively adjust a position of the back panel 20′ with respect to the back support S2 of the car seat S.

According to the second embodiment, the present invention further provides a method of shading the car seat of the vehicle, which comprises the following steps.

(1) Place the heatproof car seat arrangement within the driving chamber of the vehicle wherein the seat panel 10′ is put on the seat support S1 of the car seat S while the back panel 20′ is positioned on the back support S2 of the car seat S.

(2) Fasten the back panel 20′ on the car seat S by the fastening means 30′ to retain the back panel 20′ on the back support S2 in position.

(3) Upwardly fold the seat panel 10′ towards to the back panel 20′ for overlappedly covering the back contacting layer 21′ of the back panel 20′ by the seat contacting layer 11′ so as to shade block the heat entering into the back panel 20′ by the radiation shield layer 12′.

Therefore, when the driver gets in the vehicle, he or she may simply fold the seat panel 10′ downwardly on the seat support S1 of the vehicle so that the seat contacting layer 11′ and the back contacting layer 21′ provide a cooling surface for the driver to sit thereon. It is worth to mention that the heatproof car seat arrangement of the second embodiment is designed not only for the driver side of the vehicle but also for the passenger side of the vehicle for providing a cool body-contact surface of the car seat S.

It is worth to mention that since the back support S2 of the car seat S is inclinedly extended from the seat support S1 thereof, when the seat panel 10′ is folded upwardly to the back panel 20′, the seat panel 10′ inclinedly lies on back panel 20′ so as to retain the seat panel 10′ on the back panel 20′.

What is claimed is:

1. A heatproof car seat arrangement for shading a driving chamber of a vehicle comprising a car seat and a steering wheel locating within said driving chamber, comprising:
a seat panel, which is adapted for placing on a seat support of said car seat, comprising a seat contacting layer;
a back panel, which is foldably extended from said seat panel, comprising a back contacting layer and a radiation shield layer overlappedly attached thereto, wherein said back panel is capable of folding between a driving position and a shading position, wherein at said driving position, said back panel is folded towards to a back support of said car seat, so that both said seat contacting layer and said back contacting layer provide a cooling surface for body-contacting with a driver to sit thereon, and at said shading position, said back panel is folded forwardly for covering on said steering wheel and shading said seat contacting layer of said seat panel, and said radiation shield layer of said back panel faces upwardly for blocking heat entering into said driving chamber so as to keep said driving chamber in a cooling manner; and
means for detachably fastening said back panel on said back support of said car seat to retain said back panel on said back support of said car seat in position.

2. The heatproof car seat arrangement, as recited in claim 1, wherein said seat contacting layer of said seat panel and said back contacting layer of said back panel are embodied as a seat ventilating layer and a back ventilating layer respectively, wherein each of said seat and back ventilating layers comprises a plurality of heat dispersing elements connected with each other to form an air ventilating surface for said driver sitting thereon.

3. The heatproof car seat arrangement, as recited in claim 1, wherein said back panel further comprises a strengthen layer, having a web-liked shaped, overlappedly disposed between said back contacting layer and said radiation shield layer for strengthening said back panel so as to reinforce said back panel for covering on said steering wheel when said back panel is folded forward.

4. The heatproof car seat arrangement, as recited in claim 2, wherein said back panel further comprises a strengthen layer, having a web-liked shaped, overlappedly disposed between said back contacting layer and said radiation shield layer for strengthening said back panel so as to reinforce said back panel for covering on said steering wheel when said back panel is folded forward.

5. The heatproof car seat arrangement, as recited in claim 1, wherein said fastening means comprises a first fastener provided on said radiation shield layer and a second fastener which is adapted for detachably mounting on said back support of said car seat and is arranged to detachably fasten with said first fastener so as to retain said back panel on said back support of said car seat in position.

6. The heatproof car seat arrangement, as recited in claim 3, wherein said fastening means comprises a first fastener provided on said radiation shield layer and a second fastener which is adapted for detachably mounting on said back support of said car seat and is arranged to detachably fasten with said first fastener so as to retain said back panel on said back support of said car seat in position.

7. The heatproof car seat arrangement, as recited in claim 4, wherein said fastening means comprises a first fastener provided on said radiation shield layer and a second fastener which is adapted for detachably mounting on said back support of said car seat and is arranged to detachably fasten with said first fastener so as to retain said back panel on said back support of said car seat in position.

8. The heatproof car seat arrangement, as recited in claim 5, wherein said first and second fasteners are hoop and loop fasteners, wherein said second fastener is embodied as an elastic loop form adapted for tightly encircling with said back support of said car seat so as to selectively adjust a position of said second fastener on said back support to detachably fasten with said first fastener when said back panel is folded towards to said back support.

9. The heatproof car seat arrangement, as recited in claim 6, wherein said first and second fasteners are hoop and loop fasteners, wherein said second fastener is embodied as an elastic loop form adapted for tightly encircling with said back support of said car seat so as to selectively adjust a position of said second fastener on said back support to detachably fasten with said first fastener when said back panel is folded towards to said back support.

10. The heatproof car seat arrangement, as recited in claim 7, wherein said first and second fasteners are hoop and loop fasteners, wherein said second fastener is embodied as an elastic loop form adapted for tightly encircling with said back support of said car seat so as to selectively adjust a position of said second fastener on said back support to detachably fasten with said first fastener when said back panel is folded towards to said back support.

11. A heatproof car seat arrangement for a car seat comprising a seat support and a back support, comprising:
a seat panel comprising a seat contacting layer and a radiation shield layer overlappedly attached thereto, wherein said seat panel is adapted for placing on said seat support of said car seat and is arranged to fold between a driving position and a shading position;
a back panel, which is adapted for placing on said back supporting of said car seat, comprising a back contacting layer foldably extended from said seat panel, wherein at said driving position, said seat panel is arranged for folding on said seat support of said car seat so that both said seat contacting layer and said back contacting layer provide a cooling surface for body-contacting with a driver to sit thereon, and at said shading position, said seat panel is folded upwardly to overlappedly cover on said back panel, and said radiation shield layer of said seat panel faces forwardly for blocking heat entering into said back panel so as to keep said seat and back contacting layers in a cooling manner; and
means for detachably fastening said back panel on said back support of said car seat to retain said back panel on said back support of said car seat in position.

12. The heatproof car seat arrangement, as recited in claim 11, wherein said seat contacting layer of said seat panel and said back contacting layer of said back panel are embodied as a seat ventilating layer and a back ventilating layer respectively, wherein each of said seat and back ventilating layers comprises a plurality of heat dispersing elements connected with each other to form an air ventilating surface for said driver sitting thereon.

13. The heatproof car seat arrangement, as recited in claim 12, wherein said fastening means comprises an elastic band having two ends securely attaching to two opposed side edges of said back panel respectively for tightly encircling with said back support of said car seat so as to retain said back panel on said back support in position and selectively adjust a position of said back panel with respect to said back support.

14. The heatproof car seat arrangement, as recited in claim 13, wherein said seat panel further comprises a reinforcing layer, having a web-liked shaped, overlappedly disposed between said seat contacting layer and said radiation shield layer for strengthening said seat panel so as to reinforce said seat panel for covering on said back panel when said seat panel is folded upwardly.

15. A method of shading a driving chamber of a vehicle comprising a car seat and a steering wheel locating within said driving chamber, comprising the steps of:
(a) placing a heatproof car seat arrangement on said car seat of said vehicle, wherein said heat car seat arrangement comprises a seat panel comprising a seat contacting layer, arranged for putting on a seat support of said car seat, and a back panel comprising a back contacting layer foldably extended from said seat panel for positioning on a back support of said car seat, wherein one of said seat panel and said back panel comprises a radiation shield layer overlappedly attached to a rear side thereof;
(b) detachably fastening said back panel on said back support of said car seat so that said seat contacting layer and said back contacting layer provide a cooling surface for body-contacting with a driver to sit thereon; and
(c) folding said one of said seat panel and said back panel that is provided with said radiation shield layer to overlap with the other one so as to render said radiation shield layer faces out for blocking heat from reaching said seat and back contacting layers.

16. The method, as recited in claim 15, wherein, in the step (a), said radiation shield layer is overlappedly attached to said back contacting layer of said back panel, and the step (c) further comprises a step of forwardly folding said back panel to detach said back panel from said back support of said car seat for covering on said steering wheel and shading said seat panel, while said radiation shield layer of said back panel faces upwardly for blocking heat entering into said driving chamber so as to keep said driving chamber in a cooling manner.

17. The method, as recited in claim 16, wherein said heatproof car seat arrangement further comprises a first fastener provided on said radiation shield layer and a second fastener which is adapted for detachably mounting on said back support of said car seat and is arranged to detachably fasten with said first fastener so as to retain said back panel on said back support of said car seat in position.

18. The method, as recited in claim 17, wherein said first and second fasteners are hoop and loop fasteners, wherein said second fastener is embodied as an elastic loop form adapted for tightly encircling with said back support of said car seat so as to selectively adjust a position of said second fastener on said back support to detachably fasten with said first fastener when said back panel is folded towards to said back support.

19. The method, as recited in claim 15, wherein, in the step (a), said radiation shield layer is overlappedly attached to said seat contacting layer of said seat panel, and the step (c) further comprises a step of upwardly folding said seat panel to overlappedly cover on said back panel wherein said radiation shield layer of said seat panel faces forwardly for blocking heat entering into said back panel so as to keep said seat and back contacting layers in a cooling manner.

20. The method, as recited in claim 19, wherein said seat contacting layer of said seat panel and said back contacting layer of said back panel are embodied as a seat ventilating layer and a back ventilating layer respectively, wherein each of said seat and back ventilating layers comprises a plurality of heat dispersing elements connected with each other to form an air ventilating surface for said driver sitting thereon, wherein said heatproof car seat arrangement further comprises means for detachably fastening said back panel on said support of said car seat to retain said back panel on said back support of said car in position.
